(19) United States
(12) Patent Application Publication
(10) Pub. No.: US 2006/0115018 A1
(43) Pub. Date: Jun. 1, 2006

(54) Demodulation circuit

(76) Inventors: Tae Young Kang, Incheon (KR); Kyung Hwan Park, Daejeon (KR); Sang Kyun Lee, Gwangju (KR); Seong-Su Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/175,706

(22) Filed: Jul. 6, 2005

(30) Foreign Application Priority Data
Nov. 30, 2004 (KR) 2004-99116

(51) Int. Cl. H04L 27/14

(52) U.S. Cl. 375/324

(57) ABSTRACT

Provided is a demodulation circuit, including: first and second signal detectors which receive an amplitude modulation signal respectively through first and second input terminals and have different envelope reproduction speeds from each other; a first differential amplifier receiving output signals of the first and second signal detectors through first and second input nodes; a second differential amplifier receiving first and second output signals of the first differential amplifier through first and second nodes; and logic means for converting an output signal of the second differential amplifier into a logic signal. Thus, the demodulation circuit can operate at a low voltage and thus is suitable for a low power system and is also simplified in structure, and thus it can be employed in the tag circuit of the UHF-band passive type RFID system

### CROSS-REFERENCE TO RELATED APPLICATION

This application claims priority to and the benefit of Korean Patent Application No. 2004-99116, filed Nov. 30, 2004, the disclosure of which is incorporated herein by reference in its entirety.

### BACKGROUND

1. Field of the Invention

The present invention relates to a demodulator which is used in a tag of a passive type radio frequency identification (RFID) system and, more particularly, to a demodulation circuit which can generate an output signal with clear identification on an amplitude modulation signal having a small modulation depth.

2. Discussion of Related Art

In a passive type radio frequency identification (RFID) system, a tag converts an amplitude modulation signal output from a reader into a direct current (DC) signal to use as a driving current of the whole circuit in the tag while demodulating the amplitude modulation signal to decode command information. The amplitude modulation signal having a small modulation depth is suitable for obtaining high driving power, whereas the amplitude modulation signal having a large modulation depth is suitable for easily detecting an envelope during demodulation. Here, the modulation depth is defined as:
Modulation depth=(high−low)/(high+low)×100% Equation 1

For this reason, the passive type RFID system employs an encoding method that sets the duration of “high” level longer than the duration of “low” level to thereby use 100% modulation depth of duration of “low” level which is relatively short. The demodulator compares a signal passing through an envelope detector using a comparator to generate an output signal which identifies a “high” or “low” level. However, as a recognition distance of the passive type RFID system is farther, it is harder to use 100% of the modulation depth, and there may be a case where it uses 10% or 30% of the modulation depth. In this case, the demodulation may not be efficiently performed in that there is a high possibility that ripples occur in the envelope centering on a reference voltage due to, for example, amplitude noise when a reference voltage is set by using a conventional single envelope detector.

### SUMMARY OF THE INVENTION

The present invention is directed to a demodulation circuit in which a tag efficiently demodulates an amplitude modulation signal received from a tag of a passive type radio frequency identification (RFID) system to accurately decode command information from a reader.

The present invention is also directed to a demodulation circuit which generates an output signal with clear identification on level of an amplitude modulation signal having a small modulation depth.

One aspect of the present invention is to provide a demodulation circuit, including: first and second signal detectors which receive an amplitude modulation signal respectively through first and second input terminals and have different envelope reproduction speeds from each other; a first differential amplifier receiving output signals of the first and second signal detectors through first and second input nodes; a second differential amplifier receiving first and second output signals of the first differential amplifier through first and second nodes; and logic means for converting an output signal of the second differential amplifier into a logic signal.

The first signal detector may include a first capacitor and a diode which are serially connected between the first input terminal and an output node, and a second capacitor connected between the output node and the second input terminal; and the second signal detector may include a first capacitor and a diode which are serially connected between the first input terminal and an output node, and a second capacitor connected between the output node and the second input terminal, wherein the first capacitor of the first signal detector and the first capacitor of the second signal detector are different in size.

The first differential amplifier may include: a first transistor which is connected between a power voltage and a node N1 and receives a reference voltage via its gate; a second transistor which is connected between the node N1 and a first output node N2 and has a gate connected to an output node of the first signal detector; a third transistor connected between the first output node N2 and a ground; a fourth transistor which is connected between the node N1 and a second output node N3 and has a gate connected to an output node of the second signal detector; and a fifth transistor which is connected between the second output node N3 and a ground and has a gate connected to the second output node N3 and the gate of the third transistor.

The second differential amplifier may include: a first transistor which is connected between a power voltage and a first node N1 and receives a reference voltage via its gate; a second transistor which is connected between the first node N1 and an output node N2 and has a gate connected to an output node of the first differential amplifier; a third transistor connected between the output node N2 and a ground; a fourth transistor which is connected between the first node N1 and a second node N3 and has a gate connected to another output node of the first differential amplifier; and a fifth transistor which is connected between the second node N3 and a ground and has a gate connected to the second node N3 and the gate of the third transistor.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a circuit diagram of a demodulation circuit according to an embodiment of the present invention;

FIG. 2 is a wave diagram of an amplitude modulation signal input to a tag;

FIG. 3 is a wave diagram of signals of output nodes A and B of FIG. 1 when the signal of FIG. 2 is input;

FIG. 4 is a wave diagram of a signal of an output node C of FIG. 1 when the signal of FIG. 2 is input; and

FIG. 5 is a wave diagram of a signal of an output node D of FIG. 1 when the signal of FIG. 2 is input.

### DETAILED DESCRIPTION OF PREFERRED EMBODIMENTS

In the passive type RFID system, if a weak amplitude modulation signal is input to a tag, since an amplitude difference of the amplitude modulation signal having information of a “high” or “low” level is too small, it is difficult to efficiently detect the envelope and generate an output signal which identifies a “high” or “low” level using this signal. The amplitude modulation signal used in the RFID system is basically for identifying a “high” or “low” level, and so the shape of the envelope is not important. Thus, it is important to output a signal which clearly identifies a “high” or “low” level.

In the present invention, sizes of capacitors of signal detectors which are parallel-coupled are differently set to make envelope reproduction speeds different. Thus, if a weak amplitude modulation signal is input, a signal difference between a circuit that the envelope reproduction speed is fast and a circuit that the envelope reproduction speed is slow occurs. The signal difference is amplified, so that an output signal which clearly identifies a “high” or “low” level is generated.

A preferred embodiment of the present invention will be explained in detail with reference to the accompanying drawings. The embodiment of the present invention is provided to be sufficiently understood by those skilled in the art, and a variety of modifications and variations may be made to the present invention, and the scope of the present invention is not limited to this embodiment.

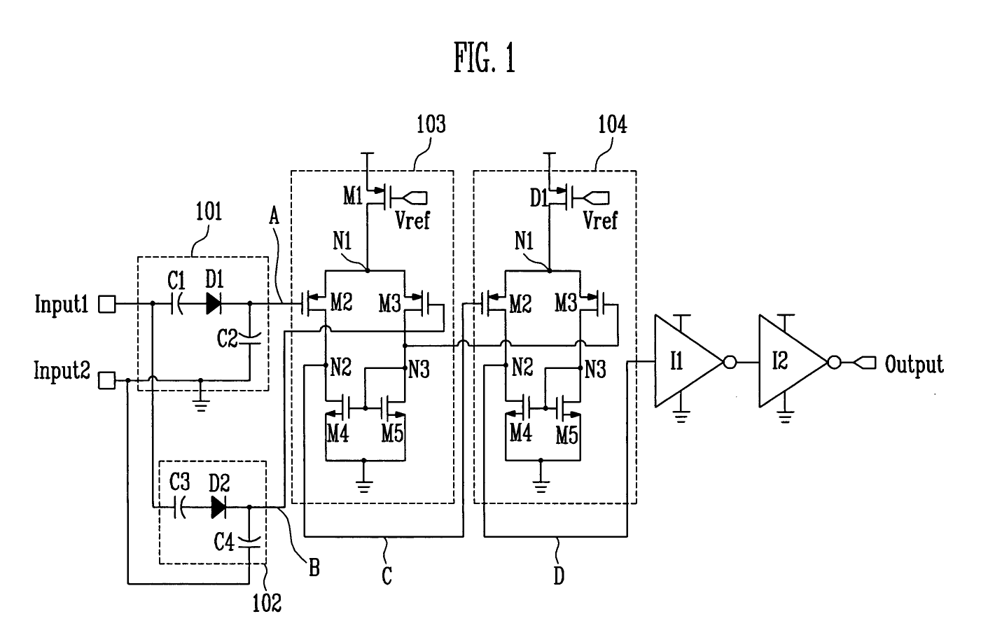

FIG. 1 is a circuit diagram of a demodulation circuit according to an embodiment of the present invention.

An amplitude modulation signal received from an antenna is input through first and second input terminals Input 1 and Input 2. Here, the second input terminal Input 2 is coupled to a ground.

First and second signal detectors 101 and 102 receive the amplitude modulation signal through the first and second imputer terminals Input 1 and Input2, respectively. Output signals of the first and second signal detectors 101 and 102 are provided to input nodes of a first differential amplifier 103, and output signals of the first differential amplifier 103 are respectively provided to input nodes of a second differential amplifier 104. An output signal of the second differential amplifier 104 is provided to an output terminal Output via inverters I1 and I2 which are coupled in series to each other.

The first signal detector 101 includes a capacitor C1 and a diode D1 which are serially coupled between the first input terminal Input 1 and an output node A, and a capacitor C2 connected between the output node A and the second input terminal Input 2.

The second signal detector 102 includes a capacitor C3 and a diode D2 which are serially coupled between the first input terminal Input 1 and an output node B, and a capacitor C4 connected between the output node B and the second input terminal Input 2.

The first differential amplifier 103 includes: a transistor M1 which is connected between a power voltage and a node N1 and receives a reference voltage Vref via its gate; a transistor M2 which is connected between the node N1 and an output node N2 and has a gate connected to the output node A of the first signal detector 101; a transistor M4 connected between the output node N2 and a ground; a transistor M3 which is connected between the node N1 and an output node N3 and has a gate connected to the output node B of the second signal detector 102; and a transistor M5 which is connected between the output node N3 and a ground and has a gate connected to the output node N3 and the gate of the transistor M4.

The second differential amplifier 104 includes: a transistor M1 which is connected between a power voltage and a node N1 and receives a reference voltage Vref via its gate; a transistor M2 which is connected between the node N1 and an output node N2 and has a gate connected to the output node N2 of the first differential amplifier 103; a transistor M4 connected between the output node N2 and a ground; a transistor M3 which is connected between the node N1 and a node N3 and has a gate connected to the output node N3 of the first differential amplifier 103; and a transistor M5 which is connected between the output node N3 and a ground and has a gate connected to the output node N3 and the gate of the transistor M4.

Operation of the modulation circuit of FIG. 1 is described below.

The first and second signal detectors 101 and 102 reproduce the envelope fast or slow according to the input amplitude signal. That is, if the first and second signal detectors 101 and 102 control sizes of the capacitors C1 and C3 to be different from each other, multiplication and discharge occur differently from each other, so that degrees which flow the envelope of the input amplitude modulation signal become different. Accordingly, an output signal is generated when two output signals of the first and second differential amplifiers 103 and 104 which receive output signals of the first and second signal detectors 101 and 102 overlap each other. Thus, even though the output signals of the first and second signal detectors 101 and 102 are small, the first and second differential amplifiers 103 and 104 operate, so that it is possible to detect a low power signal which is as low as driving power of a schottky diode.

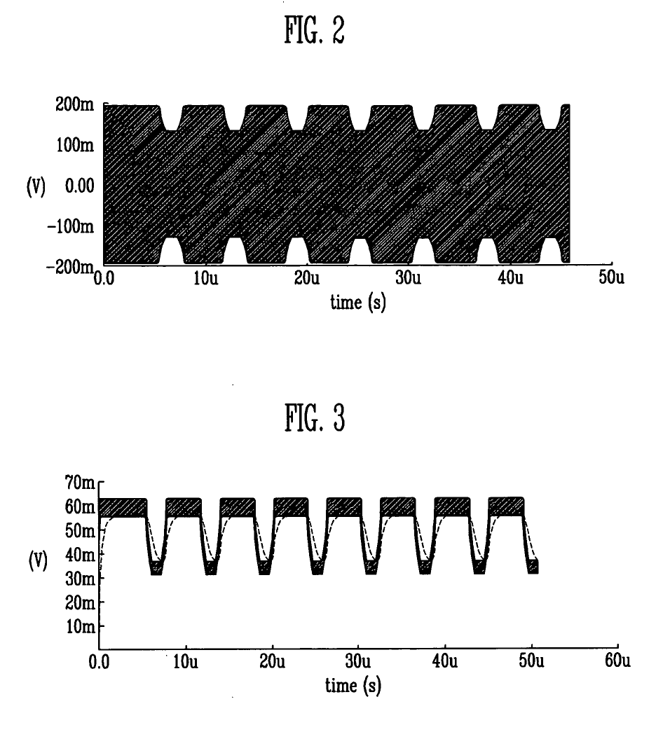

FIG. 2 is a wave diagram of an amplitude modulation signal input through the first and second input terminals Input 1 and Input 2, and FIG. 3 is a wave diagram of signals of the node A of the first signal detector 101 and the node B of the second signal detector 102 when the amplitude modulation signal is input.

Due to a size difference between the capacitors C1 and C3, a speed difference occurs during the process of reproducing the envelope. If a signal difference between the output signals of the first and second signal detectors 101 and 102 occurs, the signal difference occurs only during the transition from a “high” level to a “low” level or vice versa. Thus, the signal difference is amplified by the first and second differential amplifiers 103 and 104, so that a “high” level and a “low” level can be identified clearly. In the embodiment of the present invention, due to an amplification difference, the two differential amplifiers 103 and 104 are cascade-connected.

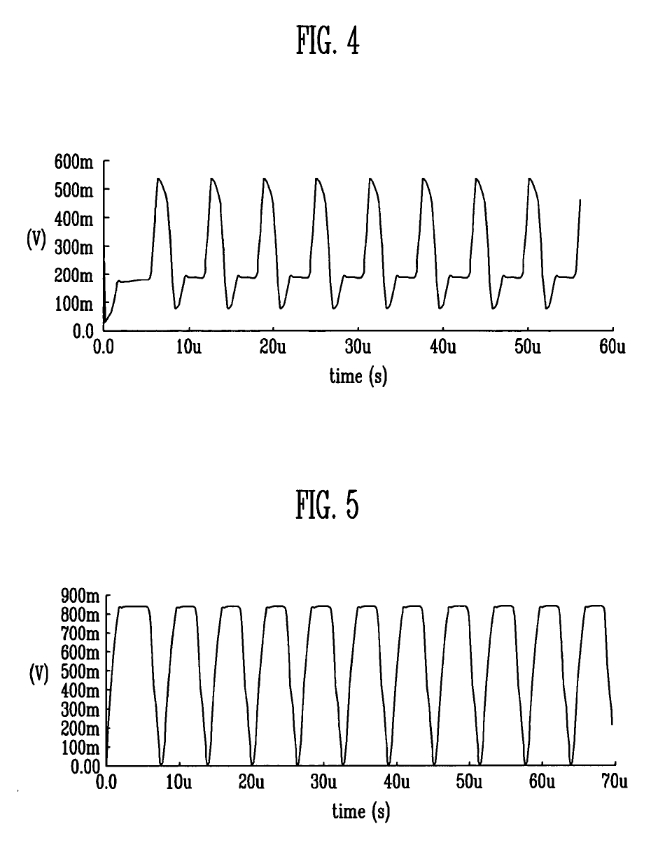

FIG. 4 is a wave diagram of a signal of the output node C of the first differential amplifier 103 when the amplitude modulation signal is input, and FIG. 5 is a wave diagram of a signal of the output node D of the first differential amplifier 104 when the amplitude modulation signal is input.

The inverters I1 and I2 serve to convert the output signal of the second differential amplifier 104 into a digital logic signal which can be input to a tag logic circuit.

As described herein before, according to the present invention, the envelope of the amplitude modulation signals having various modulation depths can be detected. In particular, in the case where the diodes of the two signal detectors are comprised of the schottky diodes, the differential amplifier operates by even a signal in which the input amplitude is as small as 0.2 V to 0.3 V and the modulation depth is 10%. Thus, in the case where the reader uses a transmission power of 36 dBM at a 900 MHz band, demodulation is possible at a distance of more than 5 m. Thus, the demodulation circuit can operate at a low voltage and thus is suitable for a low power system and is also simplified in structure, and thus it can be employed in the tag circuit of the UHF-band passive type RFID system.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A demodulation circuit, comprising:
first and second signal detectors which receive an amplitude modulation signal respectively through first and second input terminals and have different envelope reproduction speeds from each other;
a first differential amplifier receiving output signals of the first and second signal detectors through first and second input nodes;
a second differential amplifier receiving first and second output signals of the first differential amplifier through first and second nodes; and
logic means for converting an output signal of the second differential amplifier into a logic signal.

2. The demodulation circuit of claim 1, wherein the second input terminal is connected to a ground.

3. The demodulation circuit of claim 1, wherein the first signal detector includes a first capacitor and a diode which are serially connected between the first input terminal and an output node, and a second capacitor connected between the output node and the second input terminal; and the second signal detector includes a first capacitor and a diode which are serially connected between the first input terminal and an output node, and a second capacitor connected between the output node and the second input terminal, the first capacitor of the first signal detector and the first capacitor of the second signal detector being different in size to have different envelope reproduction speeds from each other.

4. The demodulation circuit of claim 1, wherein the first differential amplifier includes:
a first transistor which is connected between a power voltage and a node N1 and receives a reference voltage via a gate thereof;
a second transistor which is connected between the node N1 and a first output node N2 and has a gate connected to an output node of the first signal detector;
a third transistor connected between the first output node N2 and a ground;
a fourth transistor which is connected between the node N1 and a second output node N3 and has a gate connected to an output node of the second signal detector; and
a fifth transistor which is connected between the second output node N3 and a ground and has a gate connected to the second output node N3 and a gate of the third transistor.

5. The demodulation circuit of claim 1, wherein the second differential amplifier includes:
a first transistor which is connected between a power voltage and a first node N1 and receives a reference voltage via a gate thereof;
a second transistor which is connected between the first node N1 and an output node N2 and has a gate connected to an output node of the first differential amplifier;
a third transistor connected between the output node N2 and a ground;
a fourth transistor which is connected between the first node N1 and a second node N3 and has a gate connected to another output node of the first differential amplifier; and
a fifth transistor which is connected between the second node N3 and a ground and has a gate connected to the second node N3 and the gate of the third transistor.

6. The demodulation circuit of claim 1, wherein the logic means includes two inverters which are connected in series to each other.
